(19) United States
(12) Patent Application Publication
(10) Pub. No.: US 2020/0127283 A1
(43) Pub. Date: Apr. 23, 2020

(54) POSITIVE ELECTRODE MATERIAL FOR LITHIUM-ION SECONDARY BATTERY, POSITIVE ELECTRODE FOR LITHIUM-ION SECONDARY BATTERY, AND LITHIUM-ION SECONDARY BATTERY

(71) Applicant: Honda Motor Co.,Ltd., Tokyo (JP)

(72) Inventors: Kazuhiro ARAKI, Saitama (JP); Taku MATSUZAKA, Saitama (JP)

(73) Assignee: Honda Motor Co.,Ltd., Tokyo (JP)

(21) Appl. No.: 16/656,518

(22) Filed: Oct. 17, 2019

(30) Foreign Application Priority Data
Oct. 19, 2018 (JP) 2018-197573

(51) Int. Cl. H01M 4/36; H01M 4/505; H01M 4/525; H01M 4/58; H01M 10/0525

(52) U.S. Cl. CPC H01M 4/364; H01M 4/505; H01M 2004/028; H01M 4/5825; H01M 10/0525; H01M 4/525

(57) ABSTRACT

A positive electrode material for lithium-ion secondary battery, a positive electrode for lithium-ion secondary battery, and a lithium-ion secondary battery using the positive electrode for lithium-ion secondary battery including the positive electrode material for lithium-ion secondary battery are provided. A lithium-containing transition metal oxide with a high capacity and an olivine type active substance with a high potential are blended to form the positive electrode material. Specifically, the positive electrode material is formed in which a first positive electrode active substance and a second positive electrode active substance are contained, the first positive electrode active substance is a lithium-transition metal composite oxide containing nickel, and the second positive electrode active substance is an olivine type active substance having 50% or more of a total capacity in a potential area of 4.2-4.1 V when a counter electrode is lithium.

### CROSS-REFERENCE TO RELATED APPLICATION

This application claims the priority of Japan patent application serial no. 2018-197573, filed on Oct. 19, 2018. The entirety of the above-mentioned patent application is hereby incorporated by reference herein and made a part of this specification.

### BACKGROUND OF THE DISCLOSURE

### Technical Field

The disclosure relates to a positive electrode material for lithium-ion secondary battery, a positive electrode for lithium-ion secondary battery, and a lithium-ion secondary battery using the positive electrode for lithium-ion secondary battery including the positive electrode material for lithium-ion secondary battery.

### Related Art

Conventionally, a lithium-ion secondary battery is widespread as a secondary battery having a high energy density. The lithium-ion secondary battery which uses liquid as an electrolyte has a structure in which a separator is present between a positive electrode and a negative electrode and the liquid electrolyte (an electrolysis solution) is filled.

The electrolysis solution of the lithium-ion secondary battery is usually a flammable organic solvent, and thus safety against heat in particular may become a problem. Therefore, a solid-state battery using a flame-retardant solid electrolyte in place of the organic liquid electrolyte is also proposed (see patent literature 1).

The solid-state secondary battery includes, between a positive electrode and a negative electrode, an inorganic solid electrolyte, an organic solid electrolyte or a gelatinous solid electrolyte as an electrolyte layer. Compared with the battery using the electrolysis solution, the solid-state battery with the solid electrolyte can solve the problem of heat and have a high capacity and/or a high voltage; furthermore, the solid-state battery can also meet a demand for compactness.

The aforementioned lithium-ion secondary battery uses cobalt as an active substance of the positive electrode. However, cobalt is a valuable substance that has a small reserve as a resource. Moreover, when a content of the cobalt is reduced to form the positive electrode, in the obtained lithium-ion secondary battery, a discharge capacity is decreased, or durability is deteriorated.

Here, as a method that can suppress the decrease in the discharge capacity and the deterioration of the durability even if the usage of the cobalt is reduced, the following method is considered in which two kinds of positive electrode materials, namely a positive electrode material with a high capacity and a positive electrode material with a high potential, are mixed to be used.

For example, in patent literature 1, a positive electrode including LiNixCo_{y}Mn_{z}O₂ and lithium manganese iron phosphate is recited (see patent literature 1). A battery using the positive electrode recited in patent literature 1 is a battery in which an energy density is improved by improving an initial coulomb efficiency while safety is kept comparatively high.

In addition, in non-patent literature 1, a mixed positive electrode of NCM523 and LMFP is recited (see non-patent literature 1). In non-patent literature 1, it is recited that a cycle characteristic, a rate characteristic or the like is improved by a mixture ratio than in a case of using NCM523 alone.

In addition, it is also proposed to mix a NCA system or a NCM system with an olivine iron active substance to use (see patent literature 2). In patent literature 2, a positive electrode which has a mass ratio of olivine iron of 0.05 to 0.40 is recited, and the positive electrode safety is ensured by separating the positive electrode and a conductive material by cross-linking a binder during heating.

In addition, a mixture of a NCM system and an olivine iron Mn system is also proposed (see patent literature 3). In patent literature 3, a positive electrode which has an olivine ratio of 25% to 60% is recited, and a high temperature durability of the positive electrode is improved while a high capacity is maintained.

However, in any one of the positive electrodes of the above related art, the positive electrode material with a high capacity is mixed with a positive electrode material (olivine) with a low operation voltage, and thus the battery that is obtained has a low energy density.

### LITERATURE OF RELATED ART

### Patent Literature

[Patent literature 1] International Publication No. 2010/053174

[Patent literature 2] Japanese Laid-Open No. 2018-006129

[Patent literature 3] Japanese Laid-Open No. 2007-317534

### [Non-Patent literature]

[Non-patent literature 1] Journal of The Electrochemical Society, 165(2)A142-A148(2018)

The disclosure provides a positive electrode material for lithium-ion secondary battery, a positive electrode for lithium-ion secondary battery, and a lithium-ion secondary battery using the positive electrode for lithium-ion secondary battery including the positive electrode material for lithium-ion secondary battery by which a lithium-ion secondary battery having a high energy density can be achieved even if usage of cobalt is reduced.

The present inventor has made extensive studies to solve the above problems and found that if a lithium-containing transition metal oxide with a high capacity and an olivine type active substance with a high potential are blended to make a positive electrode material, the above problems can be solved, thereby accomplishing the disclosure.

### SUMMARY

The disclosure is a positive electrode material for lithium-ion secondary battery which is a positive electrode material for configuring the positive electrode of a lithium-ion secondary battery, wherein the positive electrode material contains a first positive electrode active substance and a second positive electrode active substance; the first positive electrode active substance is a lithium-transition metal composite oxide containing nickel; the second positive electrode active substance is an olivine type active substance having 50% or more of a total capacity in a potential area of 4.2-4.1 V when a counter electrode is lithium; and a ratio of the first positive electrode active substance with respect to the total of the first positive electrode active substance and the second positive electrode active substance is 50 mass % or more and 80 mass % or less.

A positive electrode for lithium-ion secondary battery including the positive electrode material for lithium-ion secondary battery is provided.

A lithium-ion secondary battery including the positive electrode for lithium-ion secondary battery including the positive electrode material for lithium-ion secondary battery, a negative electrode, and an electrolyte is provided.

### BRIEF DESCRIPTION OF THE DRAWINGS

FIG. 1 is a discharge curve of a lithium-ion secondary battery of example 1.

FIG. 2 is a discharge curve of a lithium-ion secondary battery of example 2.

FIG. 3 is a discharge curve of a lithium-ion secondary battery of example 3.

FIG. 4 is a discharge curve of a lithium-ion secondary battery of example 4.

FIG. 5 is a discharge curve of a lithium-ion secondary battery of comparison example 1.

FIG. 6 is a discharge curve of a lithium-ion secondary battery of comparison example 2.

FIG. 7 are discharge curves of a lithium-ion secondary battery in cases of using LVP and LVPF alone.

### DESCRIPTION OF THE EMBODIMENTS

According to the positive electrode material for lithium-ion secondary battery of the disclosure, the lithium-ion secondary battery that has a high energy density while reducing the usage of the cobalt can be achieved.

The disclosure is described below. However, the description below only illustrates the disclosure, and the disclosure is not limited hereto.

<Positive Electrode Material for Lithium-Ion Secondary Battery>

A positive electrode material for lithium-ion secondary battery of the disclosure contains a first positive electrode active substance and a second positive electrode active substance. The first positive electrode active substance is a lithium-transition metal composite oxide containing nickel, and the second positive electrode active substance is an olivine type active substance having 50% or more of a total capacity in a potential area of 4.2-4.1 V when a counter electrode is lithium.

A battery which the positive electrode material for lithium-ion secondary battery of the disclosure is applied to is not particularly limited. The battery may be a liquid-system lithium-ion secondary battery including a liquid electrolyte, or a solid-state battery including a solid-state or gelatinous electrolyte. In addition, when the positive electrode material for lithium-ion secondary battery of the disclosure is applied to the battery including a solid-state or gelatinous electrolyte, the electrolyte may be organic or inorganic.

[First Positive Electrode Active Substance]

The first positive electrode active substance which is a constituent ingredient of the positive electrode material for lithium-ion secondary battery of the disclosure is a lithium-transition metal composite oxide containing nickel. In the disclosure, the first positive electrode active substance is not particularly limited as long as nickel and lithium are contained as constituent metal elements, and a well-known substance can be used as the positive electrode active substance of the lithium-ion secondary battery.

Therefore, the first positive electrode active substance used in the disclosure may be an oxide including lithium and nickel as constituent metal elements, an oxide including at least one kind of element other than lithium and nickel as a constituent metal element and the like.

The element other than lithium and nickel may be, for example, Co, Mn, Al, Cr, Fe, V, Mg, Ca, Na, Ti, Zr, Nb, Mo, W, Cu, Zn, Ga, In, Sn, La, Ce and the like, and not just one but two or more kinds of these metal elements may be included.

The first positive electrode active substance used in the disclosure may be, for example, a lithium nickel cobalt aluminum oxide (NCA) represented by general formula (1) below.

LiₜNi_{1-x-y}CoₓAl_{y}O₂ (1)

(in the formula, 0.95≤t≤1.15, 0≤x≤0.3, 0.1≤y≤0.2, x+y<0.5)

Still another first positive electrode active substance used in the disclosure may be, for example, a lithium nickel cobalt manganese oxide (NCM) represented by general formula (2) below. NCM is used as the first positive electrode active substance used in the disclosure in that an energy density per volume is high and a thermal stability is also excellent.

LiNiₐCo_{b}Mn_{c}O₂ (2)

(in the formula, 0<a<1, 0<b<1, 0<c<1, and a+b+c=1)

Furthermore, according to the positive electrode material for lithium-ion secondary battery of the disclosure, even if the usage of cobalt is reduced, a lithium-ion secondary battery having a high energy density can be achieved, and thus the effect of the disclosure can be better exhibited when a substance having a low content ratio of cobalt is used as the first positive electrode active substance.

[Second Positive Electrode Active Substance]

The second positive electrode active substance which is a constituent ingredient of the positive electrode material for lithium-ion secondary battery of the disclosure is an olivine type active substance having 50% or more of the total capacity in the potential area of 4.2-4.1 V when the counter electrode is lithium.

The olivine type active substance having 50% or more of the total capacity in the potential area of 4.2-4.1 V when the counter electrode is lithium is thus an olivine type active substance with a high potential. The positive electrode material for lithium-ion secondary battery of the disclosure uses the olivine type active substance with a high potential as the second positive electrode active substance and mixes the second positive electrode active substance with the first positive electrode active substance which is a lithium-containing transition metal oxide with a high capacity, and thereby even if the usage of cobalt is reduced, the lithium-ion secondary battery with a high energy density can be achieved.

The second positive electrode active substance used in the disclosure is a lithium vanadium phosphate compound. If the second positive electrode active substance is a lithium vanadium phosphate compound, it may be an olivine type active substance having 50% or more of the total capacity in the potential area of 4.2-4.1 V, that is, may be an olivine type active substance with a high potential.

Because oxygen forms a covalent bond with phosphorus, the lithium vanadium phosphate compound does not generate oxygen even in a high temperature environment. Therefore, by containing the lithium vanadium phosphate compound as the second positive electrode active substance, high safety can be obtained.

In addition, the lithium vanadium phosphate compound with vanadium in central metals may also be a positive electrode of a multi-electron reaction system.

The lithium vanadium phosphate compound which is used as the second positive electrode active substance may be, for example, LiVP₂O₇ or Li₃V₂(PO₄)₃ which is called LVP, or LiVPO₄F which is called LVPF. In the disclosure, not just one but two or more of the second positive electrode active substance may be mixed to be used.

Furthermore, the V and/or Li in the above general formulas of LVP and LVPF may be partially substituted by elements such as Fe, Al, Cr, Mg, Mn, Ni, Ti and the like. In addition, in the phosphoric acid (PO₄) part, a trace amount of other anions such as (BO₃), (WO₄), (MoO₄), (SiO₄) and the like may be solid-solved.

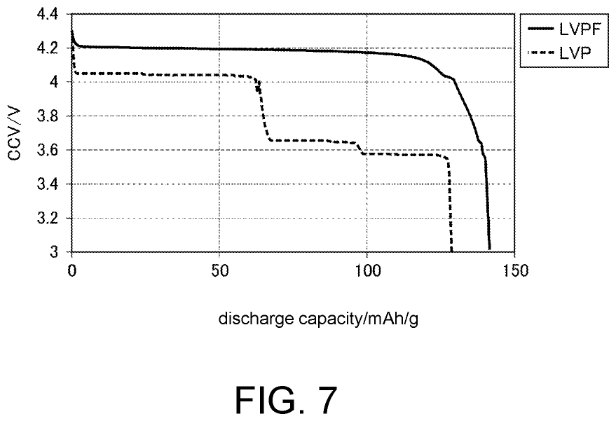

FIG. 7 shows discharge curves of the lithium-ion secondary battery in cases that the LVP and the LVPF are respectively used as the positive electrode active substance alone. As shown in FIG. 7, compared with the LVP, the LVPF has a higher voltage and a greater capacity. Therefore, in the disclosure, when the LVPF is used as the second positive electrode active substance, a battery with a higher energy density can be achieved. Furthermore, the LVPF is a material which has a great theoretical capacity (156 mAh/g), and from which an inductive effect of fluorine can be greatly expected.

As for the second positive electrode active substance used in the disclosure, LiVP₂O₇ or Li₃V₂(PO₄)₃ is particularly in the LVP, and LiVPO₄F is in the LVPF. As shown above, the LVPF is compared with the LVP, and thus a substance having a structural formula of LiVPO₄F is second positive electrode active substance in the disclosure.

[Composition of First Positive Electrode Active Substance and Second Positive Electrode Active Substance]

In the positive electrode material for lithium-ion secondary battery of the disclosure, a ratio of the first positive electrode active substance to a total of the first positive electrode active substance and the second positive electrode active substance is 50 mass % or more and 80 mass % or less. The ratio is 50 mass % or more and 70 mass % or less, and 50 mass % or more and 60 mass % or less.

If the ratio of the first positive electrode active substance to the total of the first positive electrode active substance and the second positive electrode active substance is 50 mass % or more and 80 mass % or less, a low temperature output performance of the obtained lithium-ion secondary battery is improved, and high thermal safety can be achieved.

[Other Ingredients]

The positive electrode material for lithium-ion secondary battery of the disclosure may also include, in addition to the first positive electrode active substance and the second positive electrode active substance, optional well-known ingredient as a constituent ingredient of the positive electrode of the lithium-ion secondary battery.

Other optional ingredients may be, for example, a conductive assistant, a binder, a solid electrolyte or the like. The conductive assistant may be, for example, acetylene black, carbon nanotube, graphene, graphite particles or the like. The binder may be, for example, polyvinylidene fluoride (PVDF), polyvinylidene chloride (PVDC), polyethylene oxide (PEO), polypropylene oxide (PPO), polyethylene oxide-polypropylene oxide copolymer (PEO-PPO) or the like.

When the positive electrode material for lithium-ion secondary battery of the disclosure contains other optional ingredients, a blending amount of the optional ingredients is not particularly limited. The blending amount may be in a normal range in which the positive electrode material for lithium-ion secondary battery is formed.

[Manufacturing Method of Positive Electrode Material for Lithium-Ion Secondary Battery]

A manufacturing method of the positive electrode material for lithium-ion secondary battery of the disclosure is not particularly limited, and a well-known method can be employed. For example, the manufacturing method may be a method in which the first positive electrode active substance and the second positive electrode active substance, other optional ingredients, and a solvent are mixed by a well-known method. The paste obtained by mixing may be directly used in the manufacture of the positive electrode as an electrode mixture paste.

The solvent is not particularly limited and may be, for example, an organic solvent such as N-methyl-2-pyrrolidone (NMP), toluene, alcohol or the like, or water and so on.

<Positive Electrode for Lithium-Ion Secondary Battery>

A positive electrode for lithium-ion secondary battery of the disclosure includes the above positive electrode material for lithium-ion secondary battery of the disclosure. If the positive electrode material for lithium-ion secondary battery of the disclosure is included, structural components, shape and the like is not particularly limited. For example, a structure in which an electrode layer including the positive electrode material for lithium-ion secondary battery of the disclosure is laminated on a current collector is exemplified.

[Current Collector]

The current collector configuring the positive electrode for lithium-ion secondary battery of the disclosure is not particularly limited, and a well-known current collector used in a lithium-ion secondary battery can be used. The positive electrode current collector may be, for example, an aluminum (Al) foil, a nickel (Ni) foil, an iron (Fe) foil, a stainless steel (SUS) foil, a titanium (Ti) foil, a copper (Cu) foil or the like. A thickness of the current collector may be, but not limited to, for example 1-20 μm.

[Manufacturing Method of Positive Electrode for Lithium-Ion Secondary Battery]

The manufacturing method of the positive electrode for the lithium-ion secondary battery of the disclosure is not particularly limited, and a well-known method for manufacturing a positive electrode of lithium-ion secondary battery can be applied. For example, a method is exemplified in which an electrode paste containing the positive electrode material for lithium-ion secondary battery of the disclosure is coated on the current collector and the coated current collector is rolled after being dried.

A well-known method can be applied as the method for coating the electrode paste on the current collector. For example, the method may be roller coating using an applicator roll or the like, screen coating, blade coating, spin coating, bar coating or the like.

Furthermore, in the positive electrode for lithium-ion secondary battery of the disclosure, the positive electrode layer may be formed on at least one surface of the current collector, or be formed on both surfaces. The selection can be appropriately made according to the type or structure of the target lithium-ion secondary battery.

(Thickness of Positive Electrode Layer)

A thickness of the positive electrode layer formed on the current collector is not particularly limited and can be appropriately designed corresponding to required performance of the lithium-ion secondary battery. For example, the thickness is in a range of 20 μm-1000 μm.

<Lithium-Ion Secondary Battery>

A lithium-ion secondary battery of the disclosure includes the positive electrode for lithium-ion secondary battery including the positive electrode material for lithium-ion secondary battery of the disclosure, a negative electrode, and an electrolyte.

[Negative Electrode]

The negative electrode applied in the lithium-ion secondary battery of the disclosure is not particularly limited as long as the negative electrode functions as a negative electrode of the lithium-ion secondary battery. A material showing a lower potential compared with the positive electrode for lithium-ion secondary battery of the disclosure can be selected from well-known materials capable of forming an electrode to form any battery.

A negative electrode active substance may be, for example, natural graphite, artificial graphite, hard carbon, activated carbon, Si, SiOₓ, Sn, SnOₓ or the like.

In addition, structural components configuring the negative electrode, the shape or the like is not particularly limited. For example, a structure in which an electrode layer containing the negative electrode active substance is laminated on a current collector is exemplified. The negative electrode layer may be formed on at least one surface of the current collector, or be formed on both surfaces. The selection can be appropriately made according to the type or the structure of the target lithium-ion secondary battery.

In addition, in the electrode layer of the negative electrode, optional ingredients other than the negative electrode active substance may be blended, and the optional ingredients may be, for example, a conductive assistant, a binder, a solid electrolyte or the like.

The conductive assistant may be, for example, acetylene black, vapor-grown carbon fiber (VGCF), carbon nanotube or the like. The binder may be, for example, polyvinylidene fluoride (PVDF), styrene-butadiene rubber (SBR), methylcellulose sodium (CMC) or the like.

[Electrolyte]

An electrolyte configuring the lithium-ion secondary battery of the disclosure may be a liquid electrolysis solution, or be a solid-state or gelatinous electrolyte. The electrolyte can be applied with no particular problem as long as the electrolyte can configure the lithium-ion secondary battery.

When the electrolyte configuring the lithium-ion secondary battery of the disclosure is an electrolysis solution, the lithium salt that is used may be, for example, LiPF₆, LiFSI, LiTFSI, LiBOB, LiDFP, LiDFOB or the like. In addition, the solvent may be ethylene carbonate (EC), propylene carbonate (PC), dimethyl carbonate (DMC), ethyl methyl carbonate (EMC), diethyl carbonate (DEC), γ-butyrolactone (γBL) or the like. Furthermore, an additive can be optionally added, and the additive may be, for example, vinylene carbonate (VC), fluoroethylene carbonate (FEC), propanesultone (PS), propensultone (PRS) or the like.

[Form of Battery]

The form of the lithium-ion secondary battery of the disclosure is not particularly limited and can be appropriately selected from required shapes such as a pouch cell, a cylindrical shape, a square shape and the like. In addition, both laminated type and wound type are possible.

[Other Configurations]

The lithium-ion secondary battery of the disclosure can arbitrarily include other configurations as long as the lithium-ion secondary battery includes the positive electrode for lithium-ion secondary battery including the positive electrode material for lithium-ion secondary battery of the disclosure, the negative electrode, and the electrolyte.

Other configurations may be, for example, a separator, a positive electrode tab lead, a negative electrode tab lead, a laminate film or the like. Well-known members which can be applied to the lithium-ion secondary battery can be applied to these optional configuration members.

[Flat Portion Discharging Capacity]

The lithium-ion secondary battery of the disclosure has a flat portion discharging capacity of ½ or less of the whole. By the flat portion discharging capacity being ½ or less of the whole, the battery maintains a comparatively high potential and has a higher energy.

[Manufacturing Method of Lithium-Ion Secondary Battery]

A manufacturing method of the lithium-ion secondary battery of the disclosure is not particularly limited, and a well-known method for manufacturing a lithium-ion secondary battery can be applied.

### EXAMPLES

Examples and the like of the disclosure are described below, but the disclosure is not limited to these examples and the like.

### Example 1

[Manufacture of Positive Electrode for Lithium-Ion Secondary Battery]

NCM811 (LiNi_{0.8}Co_{0.1}Mn_{0.1}O₂) is prepared as the first positive electrode active substance, and LVPF (LiVPO₄F) is prepared as the second positive electrode active substance. In the positive electrode material, 80 mass % of the whole is the first positive electrode active substance and 20 mass % is the second positive electrode active substance; 95 mass % of the positive electrode material, 3 mass % of a carbon material acting as a conductive agent, and 2 mass % of polyvinylidene fluoride (PVDF) acting as a binder are mixed, and the obtained mixture is dispersed in an appropriate amount of N-methyl-2-pyrrolidone to manufacture a slurry. An aluminum foil with a thickness of 12 μm is prepared as a current collector, and the manufactured slurry is coated on both surfaces of the current collector with a coating amount of 21.2 mg/cm² and is dried for 10 minutes at 100° C., and thereby the positive electrode active substance layer is formed on the both surfaces of the current collector and pressed to a predetermined thickness to obtain a positive electrode for lithium-ion secondary battery.

[Manufacture of Negative Electrode for Lithium-Ion Secondary Battery]

97 mass % of natural graphite, 1 mass % of a carbon material acting as a conductive agent, 1 mass % of styrene butadiene rubber (SBR) acting as the binder, and 1 mass % of methylcellulose sodium (CMC) acting as a thickener agent are mixed, and the obtained mixture is dispersed in an appropriate amount of distillated water to manufacture a slurry. A copper foil with a thickness of 8 μm is prepared as a current collector, and the manufactured slurry is coated on both surfaces of the current collector with a coating amount of 12.3 mg/cm² and is dried for 10 minutes at 100° C., and thereby the negative electrode active substance layer is formed on the both surfaces of the current collector and pressed to a predetermined thickness to obtain the negative electrode for lithium-ion secondary battery.

[Manufacture of Lithium-Ion Secondary Battery]

The positive electrode for lithium-ion secondary battery, the negative electrode for lithium-ion secondary battery obtained above and an electrolysis solution are used to manufacture the lithium-ion secondary battery. The electrolysis solution is a solution in which 1.2 moles of LiPF₆ is dissolved in a solvent obtained by mixing ethylene carbonate, dimethyl carbonate, and ethyl methyl carbonate in a volume ratio of 3:4:3.

[Evaluation of Lithium-Ion Secondary Battery]

(Energy Density Per Positive Electrode)

For the manufactured lithium-ion secondary battery, a charge-discharge test is repeated for three times at an environmental temperature of 25° C. with a lower limit voltage of 2.7 V and an upper limit voltage of 4.2 V at a rate of 0.2 C, and the discharge capacity at the third time is set as an initial capacity. The energy density per positive electrode is calculated from the obtained initial capacity and an average operation voltage. A result is shown in table 1.

(Discharge Curve)

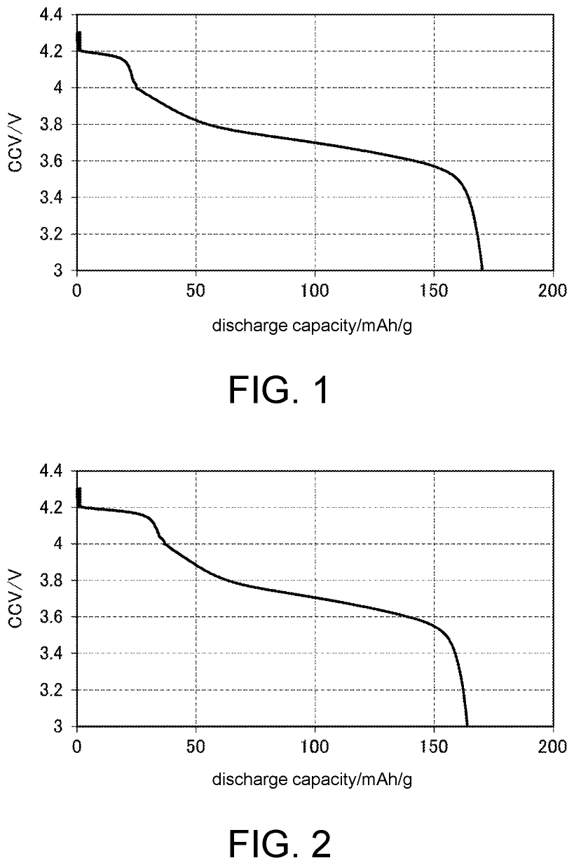

A discharge curve at the third time of the above charge-discharge test is shown in FIG. 1.

TABLE 1

| | | | Other | |
|---|---|---|---|---|
| | First positive | | positive | |
| | electrode | Second positive | electrode | Energy |
| | active | electrode active | active | density |
| | substance | substance | substance | per positive |
| | NCM811 | LVPF | LMFP | electrode |
| | (mass %) | (mass %) | (mass %) | (mWh/cm²) |
| Example 1 | 80 | 20 | 0 | 520 |
| Example 2 | 70 | 30 | 0 | 514 |
| Example 3 | 60 | 40 | 0 | 508 |
| Example 4 | 50 | 50 | 0 | 503 |
| Comparison | 35 | 35 | 30 | 441 |
| example 1 | | | | |
| Comparison | 70 | 0 | 30 | 440 |
| example 2 | | | | |

### Examples 2-4

[Manufacture of Lithium-Ion Secondary Battery]

A positive electrode for lithium-ion secondary battery and a lithium-ion secondary battery are manufactured in the same way as example 1 except that NCM811 (LiNi_{0.8}C_{00.1}Mn_{0.1}o₂) which is the first positive electrode active substance and LVPF (LiVPO₄F) which is the second positive electrode active substance are changed to the compositions shown in table 1.

[Evaluation of Lithium-Ion Secondary Battery]

(Energy Density Per Positive Electrode)

The initial capacity is measured and the energy density per positive electrode is calculated for the obtained lithium-ion secondary batteries in the same way as example 1. The result is shown in table 1.

(Discharge Curves)

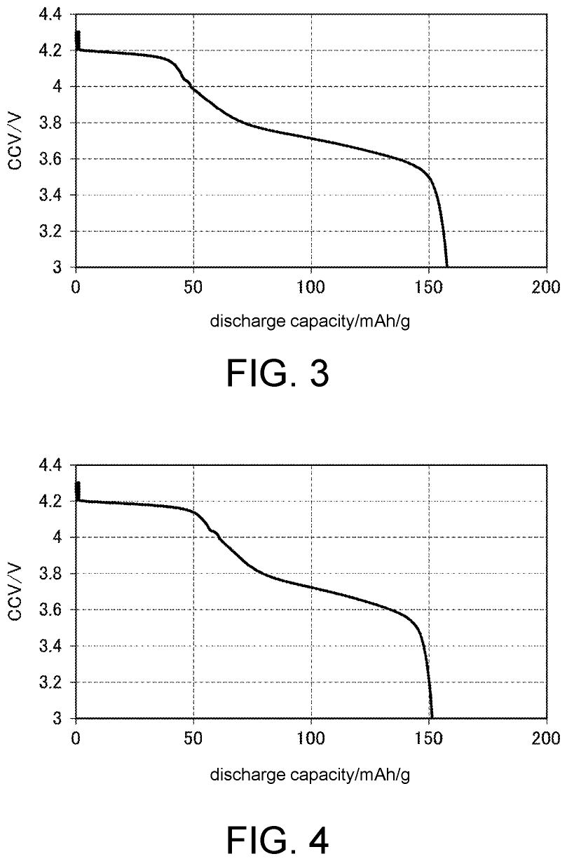

Discharge curves are obtained for the obtained lithium-ion secondary batteries in the same way as example 1. The result of example 2 is shown in FIG. 2, the result of example 3 is shown in FIG. 3, and the result of example 4 is shown in FIG. 4.

### Comparison Examples 1-2

[Manufacture of Lithium-Ion Secondary Battery]

A positive electrode for lithium-ion secondary battery and a lithium-ion secondary battery are manufactured in the same way as example 1 except that LMFP (LiMn_{0.7}Fe_{0.3}PO₄) is used as the positive electrode active substance in the composition shown in table 1.

[Evaluation of Lithium-Ion Secondary Battery]

(Energy Density Per Positive Electrode)

The initial capacity is measured and the energy density per positive electrode is calculated for the obtained lithium-ion secondary batteries in the same way as example 1. The result is shown in table 1.

(Discharge Curves)

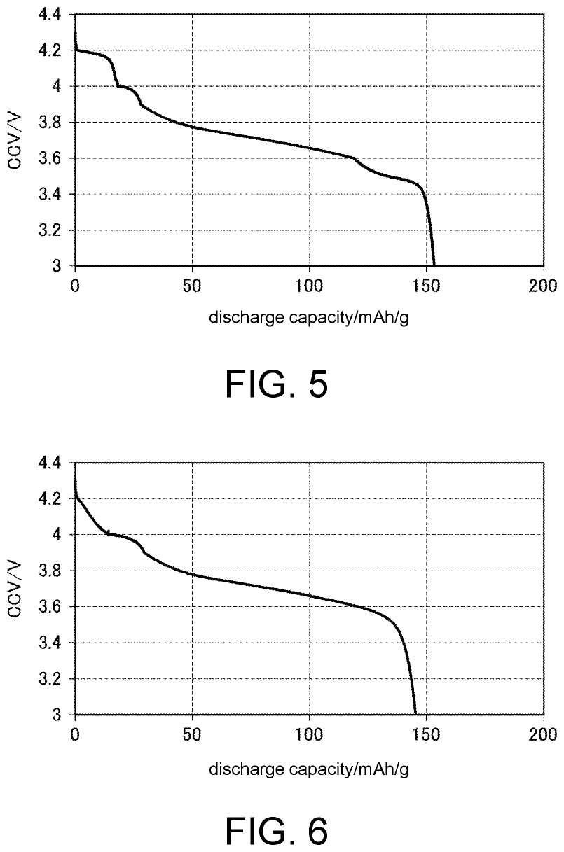

Discharge curves are obtained for to the obtained lithium-ion secondary batteries in the same way as example 1. The result of comparison example 1 is shown in FIG. 5, and the result of comparison example 2 is shown in FIG. 6.

The second positive electrode active substance may be a lithium vanadium phosphate compound.

The second positive electrode active substance may be at least one substance that is selected from a group consisting of LiVP₂O₇, Li₃V₂(PO₄)₃, and LiVPO₄F.

The lithium-ion secondary battery may have a flat portion discharging capacity of ½ or less of the whole.

What is claimed is:

1. A positive electrode material for lithium-ion secondary battery, which is a positive electrode material for configuring a positive electrode of a lithium-ion secondary battery, wherein
the positive electrode material contains a first positive electrode active substance and a second positive electrode active substance;
the first positive electrode active substance is a lithium-transition metal composite oxide containing nickel;
the second positive electrode active substance is an olivine type active substance having 50% or more of a total capacity in a potential area of 4.2-4.1 V when a counter electrode is lithium; and
a ratio of the first positive electrode active substance with respect to the total of the first positive electrode active substance and the second positive electrode active substance is 50 mass % or more and 80 mass % or less.

2. The positive electrode material for lithium-ion secondary battery according to claim 1, wherein the second positive electrode active substance is a lithium vanadium phosphate compound.

3. The positive electrode material for lithium-ion secondary battery according to claim 1, wherein the second positive electrode active substance is at least one substance that is selected from a group consisting of LiVP₂O₇, Li₃V₂(PO₄)₃, and LiVPO₄F.

4. A positive electrode for lithium-ion secondary battery comprising the positive electrode material for lithium-ion secondary battery according to claim 1.

5. A positive electrode for lithium-ion secondary battery comprising the positive electrode material for lithium-ion secondary battery according to claim 2.

6. A positive electrode for lithium-ion secondary battery comprising the positive electrode material for lithium-ion secondary battery according to claim 3.

7. A lithium-ion secondary battery comprising a positive electrode for lithium-ion secondary battery comprising the positive electrode material for lithium-ion secondary battery according to claim 1, a negative electrode, and an electrolyte.

8. A lithium-ion secondary battery comprising a positive electrode for lithium-ion secondary battery comprising the positive electrode material for lithium-ion secondary battery according to claim 2, a negative electrode, and an electrolyte.

9. A lithium-ion secondary battery comprising a positive electrode for lithium-ion secondary battery comprising the positive electrode material for lithium-ion secondary battery according to claim 3, a negative electrode, and an electrolyte.

10. The lithium-ion secondary battery according to claim 7, wherein the lithium-ion secondary battery has a flat portion discharging capacity of ½ or less of the whole.

11. The lithium-ion secondary battery according to claim 8, wherein the lithium-ion secondary battery has a flat portion discharging capacity of ½ or less of the whole.

12. The lithium-ion secondary battery according to claim 9, wherein the lithium-ion secondary battery has a flat portion discharging capacity of ½ or less of the whole.
